(19) United States
(12) Patent Application Publication
(10) Pub. No.: US 2005/0267254 A1
(43) Pub. Date: Dec. 1, 2005

(54) Functionalized urethanes and methods for use thereof

(76) Inventors: Farhad G. Mizori, La Mesa, CA (US); Stephen M. Dershem, San Diego, CA (US)

Correspondence Address: Kevin Forrestal, 10080 Willow Creek Rd, San Diego, CA, 92131, US

(21) Appl. No.: 11/120,004

(22) Filed: May 2, 2005

Related U.S. Application Data
(60) Provisional application No. 60/575,649, filed on May 28, 2004.

(51) Int. Cl. C08K 3/00

(52) U.S. Cl. 524/589

(57) ABSTRACT

The invention is based on the discovery that certain functionalized urethane compounds are useful as thermosetting resins for the electronic packaging industry. The functionalized urethane compounds described herein can be cured in a variety of ways, depending on the polymerizable moiety present in the urethane compound. In addition, the functionalized urethane compounds described herein exhibit increased thermal stability relative to known urethane compounds. The functionalized urethane compounds are readily prepared by contacting a hydroxyl-bearing compound with an isocyanate, thereby resulting in a functionalized urethane compound. In addition, the methods described herein for preparing invention urethane compounds are environmentally friendly, requiring no solvent or catalyst.

### RELATED APPLICATIONS

This application claims the benefit of priority of U.S. Provisional Application Ser. No. 60/575,649 filed May 28, 2004, the entire disclosure of which is incorporated herein by reference.

### FIELD OF THE INVENTION

The present invention relates to thermosetting adhesive compositions, methods of preparation and uses therefor. In particular, the present invention relates to functionalized urethane compounds and thermosetting compositions comprised thereof.

### BACKGROUND OF THE INVENTION

As the electronics industry advances, and production of light weight components increases, the development of new materials gives producers increased options for further improving the performance and ease of manufacture of such components. Adhesive compositions, particularly conductive adhesives, are used for a variety of purposes in the fabrication and assembly of semiconductor packages and microelectronic devices. The more prominent uses include bonding of electronic elements such as integrated circuit chips to lead frames or other substrates, and bonding of circuit packages or assemblies to printed wire boards.

Adhesives used in the electronic packaging industry typically contain a thermosetting resin combined with a filler and some type of curing initiator. These resins are primarily used in the electronics industry for the preparation of non-hermetic electronic packages. Adhesives useful for electronic packaging applications typically exhibit properties such as good mechanical strength, curing properties that do not affect the function of the component or the carrier, and thixotropic properties compatible with application to microelectronic and semiconductor components. Examples of such packages are ball grid array (BGA) assemblies, super ball grid arrays, IC memory cards, chip carriers, hybrid circuits, chip-on-board, multi-chip modules, pin grid arrays, and the like.

For all these applications, the microelectronics industry continues to require new resins that are able to meet increasing demands and varying specifications. Accordingly, there is a need for the development of materials to address the requirements of this rapidly evolving industry.

### SUMMARY OF THE INVENTION

The invention is based on the discovery that certain functionalized urethane compounds are useful as thermosetting resins for the electronic packaging industry. The functionalized urethane compounds described herein can be cured in a variety of ways, depending on the polymerizable moiety present in the urethane resin. Invention functionalized urethane compounds are readily prepared by contacting a hydroxyl-bearing compound with an isocyanate, thereby resulting in a functionalized urethane compound.

In addition, when invention compounds are incorporated into adhesive compositions, the adhesive compositions exhibit good adhesion to metal substrates, such as, for example, copper, gold, nickel, palladium, and the like. Invention functionalized urethanes also exhibit superior thermal stability compared to conventional urethanes. For example, invention functionalized urethane compounds are typically stable up to about 260° C. Other compounds of the invention are stable up to about 270° C. Certain other compounds of the invention are stable up to about 300° C. The high temperature stability of the compounds of the invention makes these compounds particularly useful as thermosetting resins in the microelectronic packaging industry. The methods described herein for preparing invention urethane compounds are environmentally friendly, requiring no solvent or catalyst.

In one embodiment of the invention, there are provided functionalized urethane compounds having the formula I: 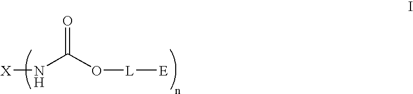
wherein:
   X is a substituted or unsubstituted aliphatic, aryl or heterocyclic;
   each E is independently a polymerizable moiety selected from the group consisting of acrylate, methacrylate, acrylamide, methacrylamide, olefin, epoxy, maleimide, vinyl ether, and vinyl ester;
   each L is independently a bond, a substituted or unsubstituted alkylene, a substituted or unsubstituted arylene, or a substituted or unsubstituted oxyalkylene linker; and
   n is 1 to about 10.

In another embodiment, there are provided adhesive compositions including at least one functionalized urethane compound as set forth above, and at least one curing initiator.

In another embodiment, there are provided die-attach pastes including:
a) about 2 weight percent to about 98 weight percent (wt %) of at least one functionalized urethane compound as set forth above, based on total weight of the composition;
b) 0 wt % to about 90 wt % of a filler;
c) about 0.1 wt % to about 5 wt % of at least one curing initiator, based on total weight of the composition;
d) about 0.1 wt % to about 4 wt %, of at least one coupling agent, based on total weight of the composition.

In other embodiments, there are provided assemblies including a first article adhered to a second article by a cured aliquot of the invention die-attach paste set forth above.

In still another embodiment, there are provided methods for adhesively attaching a first article to a second article. Such methods can be performed, for example, by
(a) applying an aliquot of an invention adhesive composition to the first article,
(b) bringing the first and second article into contact to form an assembly wherein the first article and the second article are separated only by the adhesive composition applied in (a), and
(c) subjecting the assembly to conditions suitable to cure the adhesive composition.

In yet another embodiment, there are provided methods for adhesively attaching a semiconductor die to a substrate. Such methods can be performed, for example, by (a) applying an invention die-attach paste to the substrate and/or the semiconductor die, (b) bringing the substrate and the die into contact to form an assembly wherein the substrate and the die are separated only by the die-attach paste applied in (a), and (c) subjecting the assembly to conditions suitable to cure the die-attach paste.

### BRIEF DESCRIPTION OF THE DRAWINGS

FIG. 1 illustrates some exemplary reactions of hydroxyl-functionalized compounds with isocyanates, resulting in some exemplary functionalized urethane compounds of the invention.

FIG. 2 illustrates the synthesis of an exemplary glycidyl ester-methacrylate diurethane of the invention.

### DETAILED DESCRIPTION OF THE INVENTION

It is to be understood that both the foregoing general description and the following detailed description are exemplary and explanatory only and are not restrictive of the invention claimed. As used herein, the use of the singular includes the plural unless specifically stated otherwise. As used herein, “or” means “and/or” unless stated otherwise. Furthermore, use of the term “including” as well as other forms, such as “includes,” and “included,” is not limiting.

The section headings used herein are for organizational purposes only and are not to be construed as limiting the subject matter described.

Definitions

Unless specific definitions are provided, the nomenclatures utilized in connection with, and the laboratory procedures and techniques of analytical chemistry, synthetic organic and inorganic chemistry described herein are those known in the art. Standard chemical symbols are used interchangeably with the full names represented by such symbols. Thus, for example, the terms “hydrogen” and “H” are understood to have identical meaning. Standard techniques may be used for chemical syntheses, chemical analyses, and formulation.

As used herein, the term “functionalized urethane” refers to a compound having the well-known urethane moiety (i.e., RN—(CO)—O), as well as a polymerizable moiety. In some embodiments of the invention, the term “polymerizable moiety” refers to a moiety having at least one unit of unsaturation that is capable of participating in a polymerization reaction. Typically, the unit of unsaturation is a carbon-carbon double bond. In other embodiments of the invention, the term “polymerizable moiety” refers to a ring-opening moiety, such as, for example, epoxy, oxetane, oxazoline, benzoxazine, and the like. In other embodiments, the term “polymerizable moiety” refers to a moiety that forms a ring upon polymerization, such as, for example, cyanate esters, and the like.

As used herein, “aliphatic” refers to any alkyl, alkenyl, cycloalkyl, or cycloalkenyl moiety.

As used herein, “alkyl” refers to straight or branched chain hydrocarbyl groups having from 1 up to about 100 carbon atoms. Whenever it appears herein, a numerical range, such as “1 to 100” or “C₁-C₁₀₀”, refers to each integer in the given range; e.g., “C₁-C₁₀₀alkyl” means that an alkyl group may comprise only 1 carbon atom, 2 carbon atoms, 3 carbon atoms, etc., up to and including 100 carbon atoms, although the term “alkyl” also includes instances where no numerical range of carbon atoms is designated). “Substituted alkyl” refers to alkyl moieties bearing substituents including alkyl, alkenyl, alkynyl, hydroxy, oxo, alkoxy, mercapto, cycloalkyl, substituted cycloalkyl, heterocyclic, substituted heterocyclic, aryl, substituted aryl, heteroaryl, substituted heteroaryl, aryloxy, substituted aryloxy, halogen, haloalkyl, cyano, nitro, nitrone, amino, amido, —C(O)H, —C(O)—, —C(O)—, —S—, —S(O)₂, —OC(O)—O—, —NR—C(O), —NR—C(O)—NR, —OC(O)—NR, wherein R is H or lower alkyl, acyl, oxyacyl, carboxyl, carbamate, sulfonyl, sulfonamide, sulfuryl, and the like.

As used herein, “cycloalkyl” refers to cyclic ring-containing groups typically containing in the range of about 3 up to about 8 carbon atoms, and “substituted cycloalkyl” refers to cycloalkyl groups further bearing one or more substituents as set forth above.

As used herein, “aryl” refers to aromatic groups having in the range of 6 up to 14 carbon atoms and “substituted aryl” refers to aryl groups further bearing one or more substituents as set forth above.

As used herein, “heterocyclic” refers to cyclic (i.e., ring-containing) groups containing one or more heteroatoms (e.g., N, O, S, or the like) as part of the ring structure, and having in the range of 3 up to 14 carbon atoms and “substituted heterocyclic” refers to heterocyclic groups further bearing one or more substituents as set forth above. The term heterocyclic is also intended to refer to heteroaromatic moieties. As used herein, “alkenyl” refers to straight or branched chain hydrocarbyl groups having at least one carbon-carbon double bond, and having in the range of about 2 up to about 100 carbon atoms, and “substituted alkenyl” refers to alkenyl groups further bearing one or more substituents as set forth above.

As used herein, “alkylene” refers to a divalent alkyl moiety, and “oxyalkylene” refers to an alkylene moiety containing at least one oxygen atom instead of a methylene (CH₂) unit. “Substituted alkylene” and “substituted oxyalkylene” refer to alkylene and oxyalkylene groups further bearing one or more substituents as set forth above.

As used herein, “arylene” refers to a divalent aryl moiety. “Substituted arylene” refers to arylene moieties bearing one or more substituents as set forth above.

The invention is based on the discovery that certain functionalized urethane compounds are useful as thermosetting resins for the electronic packaging industry. The functionalized urethane compounds described herein can be cured in a variety of ways, depending on the polymerizable moiety present in the urethane resin. The functionalized urethane compounds are readily prepared by contacting a hydroxyl-bearing compound with an isocyanate, thereby resulting in a functionalized urethane compound. In addition, the methods described herein for preparing invention urethane compounds are environmentally friendly, requiring no solvent or catalyst.

As used herein, the term “acrylate” refers to a compound bearing at least one moiety having the structure:

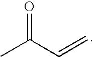

As used herein, the term “methacrylate” refers to a compound bearing at least one moiety having the structure:

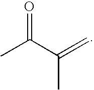

As used herein, the term “maleimide” refers to a compound bearing at least one moiety having the structure:

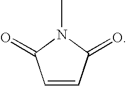

As used herein, the term “epoxy” refers to a compound bearing at least one moiety having the structure:

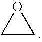

As used herein, the term “vinyl ether” refers to a compound bearing at least one moiety having the structure:

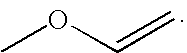

As used herein, the term “acrylamide” refers to a compound bearing at least one moiety having the structure:

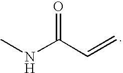

As used herein, the term “methacrylamide” refers to a compound bearing at least one moiety having the structure:

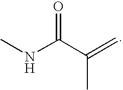

In one embodiment of the invention, there are provided functionalized urethane compounds having the formula I: 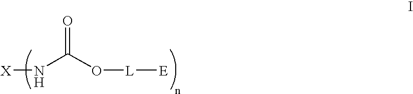
wherein:
   X is a substituted or unsubstituted aliphatic, aryl, or heterocyclic;
   each E is independently a polymerizable moiety selected from acrylate, methacrylate, arcylamide, methacrylamide, olefin, epoxy, maleimide, vinyl ether, and vinyl ester;
   each L is independently a bond or a substituted or unsubstituted alkylene, substituted or unsubstituted arylene, or substituted or unsubstituted oxyalkylene linker; and
   n is 1 to about 10.

In certain embodiments, X is a substituted or unsubstituted linear, branched, cyclic or heterocyclic aliphatic moiety having from 2 to about 100 carbon atoms. In other embodiments, X is a substituted or unsubstituted aryl or heterocyclic moiety having from about 3 to about 14 carbon atoms. In still other embodiments, X is a substituted or unsubstituted linear, branched, or cyclic aliphatic moiety having from 2 to about 50 carbon atoms.

It is understood that the variable X can be any aliphatic, aryl, or heterocyclic moiety capable of bearing at least one isocyanate moiety. Thus, in some embodiments, n is 1 to about 10. In other embodiments, n is 1 to about 5. In other embodiments, n is 1 to about 3. In certain embodiments, n is 2.

In embodiments wherein X is substituted, the substituents include but are not limited to alkyl, alkenyl, alkynyl, hydroxy, oxo, alkoxy, mercapto, cycloalkyl, substituted cycloalkyl, heterocyclic, substituted heterocyclic, aryl, substituted aryl, heteroaryl, substituted heteroaryl, aryloxy, substituted aryloxy, halogen, haloalkyl, cyano, nitro, nitrone, amino, amido, —C(O)H, —C(O)—, —C(O)—, —S—, —S(O)₂, —OC(O)—O—, —NR—C(O), —NR—C(O)—NR, —OC(O)—NR, wherein R is H or lower alkyl, acyl, oxyacyl, carboxyl, carbamate, sulfonyl, sulfonamide, sulfuryl, and the like.

The linker L is used to link the polymerizable moiety to the urethane group. In some embodiments, L is a direct bond, linking the polymerizable moiety to the urethane group. In other embodiments, L is a C₁-C₂₀ alkylene or oxyalkylene linker. In some embodiments, L is a C₁-C₁₀ alkylene or oxyalkylene linker. In other embodiments, L is a C₁-C₅ alkylene or oxyalkylene linker.

The polymerizable moiety E can be chosen from a wide variety of reactive groups. Indeed, the selection of E will depend on the type of thermosetting chemistry desired in the ultimate adhesive. For example, for an adhesive composition that is to be cured by a free-radical mechanism, a typical selection for E is acrylate, methacrylate, cyanoacrylate, maleimide, and the like. In other embodiments, E is selected from epoxies (such as phenolics, novalacs (both phenolic and cresolic) and the like), imides, cyanate esters, vinyl ethers, vinyl esters, vinyl acetates, esters, ureas, amides, olefins (such as ethylenes, propylenes, and the like), siloxanes, styrenes, oxazolines, benzoxazines, oxetanes, and the like, or combinations thereof. It is understood that the polymerizable moieties set forth above as the component E are exemplary only, and in no way limit the scope of the invention. A variety of curing mechanisms will be known to the skilled artisan, including, but not limited to free radical, ring-opening, ring-closing, ene reactions, and the like.

The functionalized urethanes of the invention are readily prepared by contacting an appropriate isocyanate with a hydroxyl substituted compound containing the desired polymerizable moiety. No solvent and no catalysts are required to prepare the functionalized urethanes of the invention, although a solvent and a catalyst may be used if desired. Thus, the preparation of invention urethanes is an environmentally friendly process. Mono-, di-, tri-, and polyfunctional isocyanates are contemplated for use in the preparation of invention compounds, provided the isocyanates are liquid at room temperature. In some embodiments, di-, tri-, or polyfunctional isocyanates are reacted with several hydroxyl-bearing compounds containing different polymerizable moieties. This results in functionalized urethanes containing several different polymerizable moieties in one functionalized urethane molecule. In other embodiments, a single hydroxyl-bearing compound containing a polymerizable moiety is reacted with an isocyanate, resulting in functionalized urethane molecules having the same polymerizable moiety.

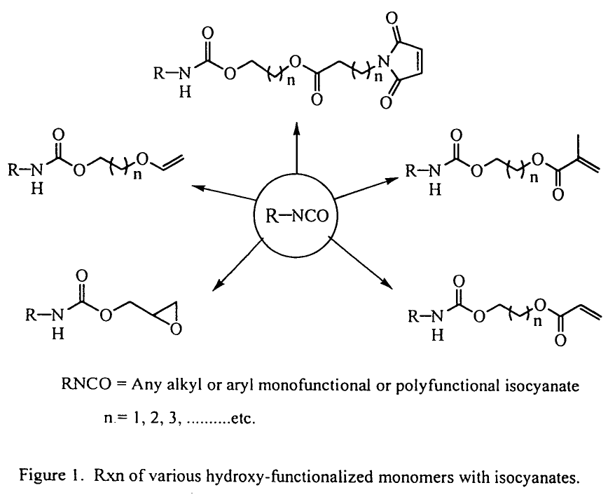

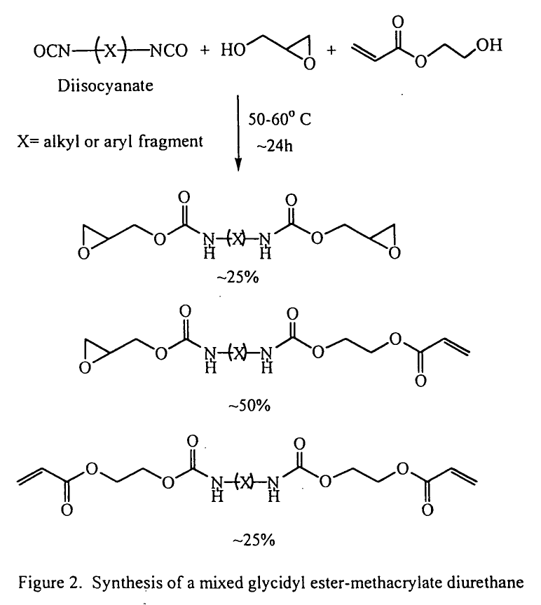

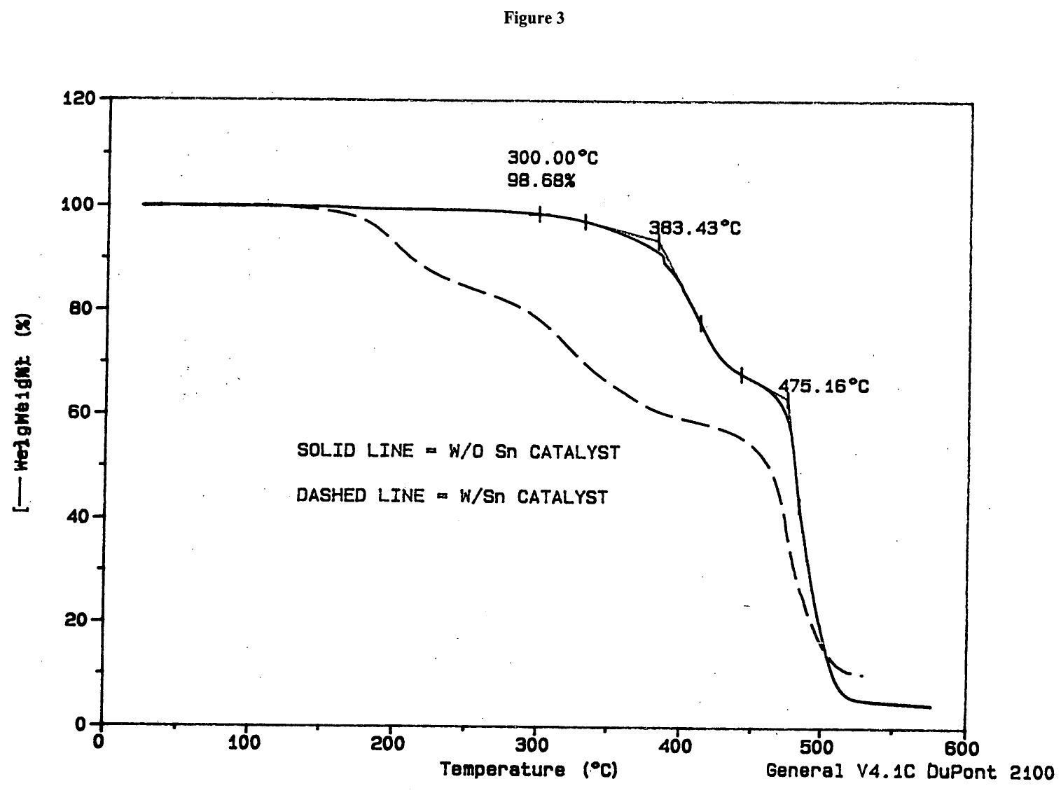

As is well-known to those skilled in the art, certain isocyanates are more reactive than others. Thus, some invention functionalized urethane compounds can be prepared at ambient temperature. In some embodiments, the reaction is carried out at an elevated temeperature, such as about 50-60° C., while in other embodiments, the reaction may require higher temperatures, such as from 70-90° C. In other embodiments, the reaction may require temperatures greater than 100° C. The reactions may be monitored by infrared spectroscopy, where formation of the urethane is easily observed by monitoring the disappearance of the characteristic isocyanate signal at about 2200 cm⁻¹. FIGS. 1 and 2 illustrate exemplary synthetic reactions for the preparation of invention functionalized urethanes.

The functionalized urethane compounds set forth herein exhibit increased thermal stability compared to known urethane compounds. For example as shown in FIG. 3, Compound 1B (set forth below) exhibits remarkable thermal stability up to about 300° C. (as measured by thermal gravimetric analysis).

As set forth above, a wide variety of polymerizable moieties can be incorporated into the functionalized urethane compounds of the invention. Some exemplary invention compounds include but are not limited to compounds having the formulae set forth below: 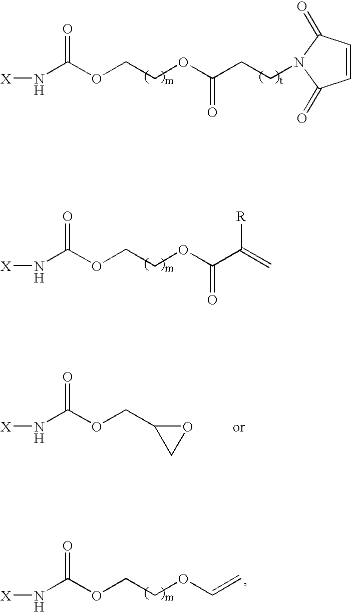
wherein
   X is as defined above,
   m and t are each independently 1 to about 20, and
   R is H or methyl.

Some additional invention compounds are set forth below: 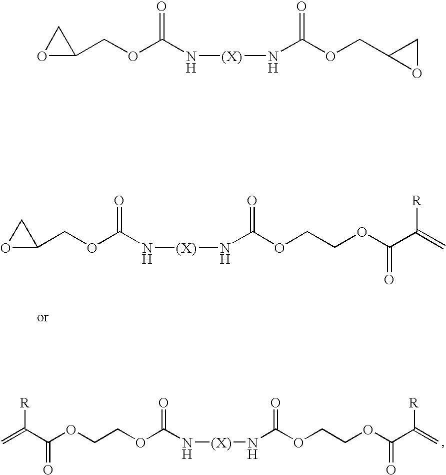
wherein
   X is defined as above, and
   each R is independently H or methyl.

Additional nonlimitng examples of invention functionalized urethane compounds are set forth below: 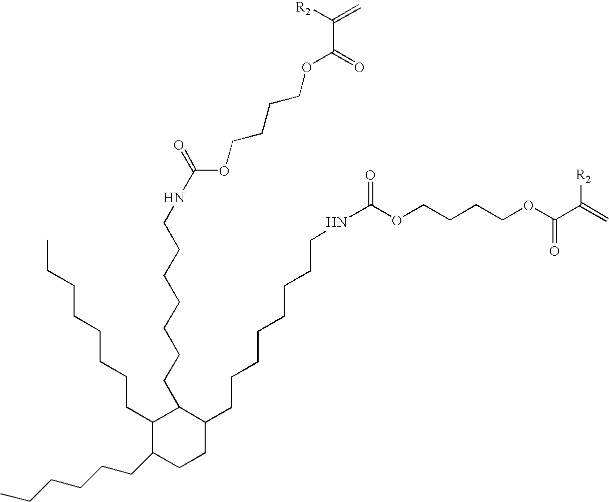
wherein R₁ and R₂ are each independently —H or methyl;
   R₁═R₂═H Compound 1a
   R₁═H R₂═Methyl Compound 1b 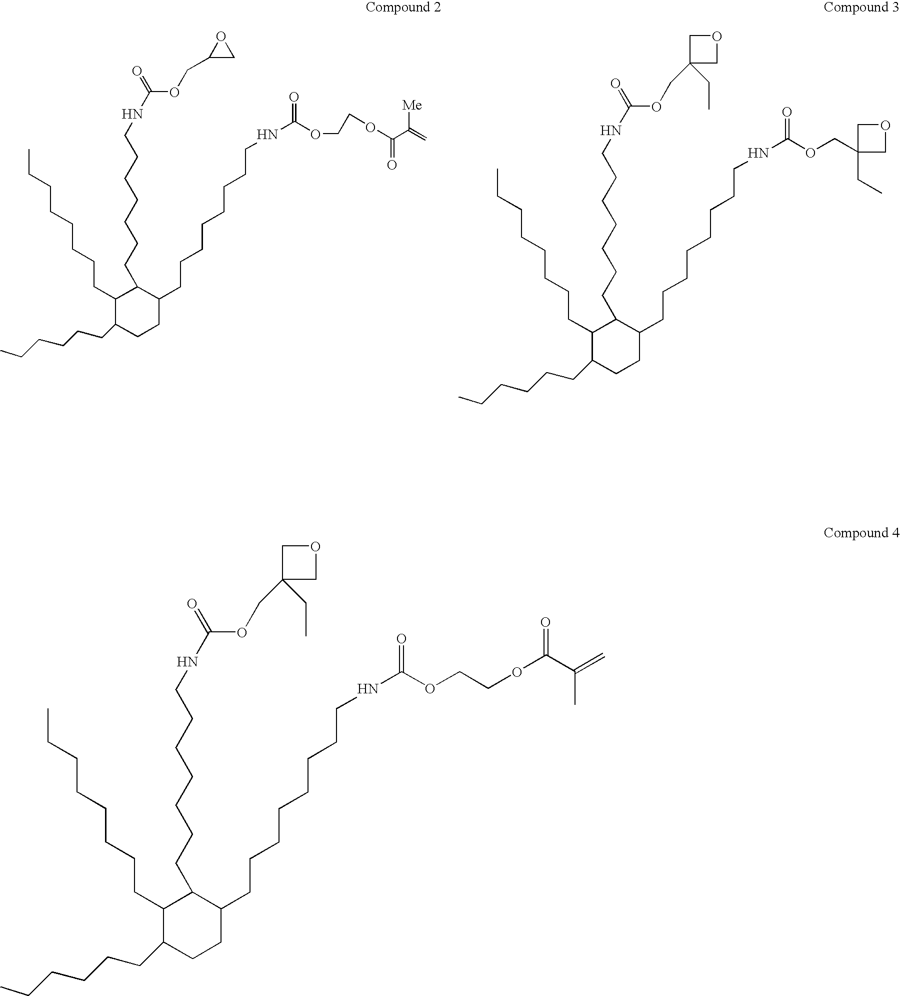 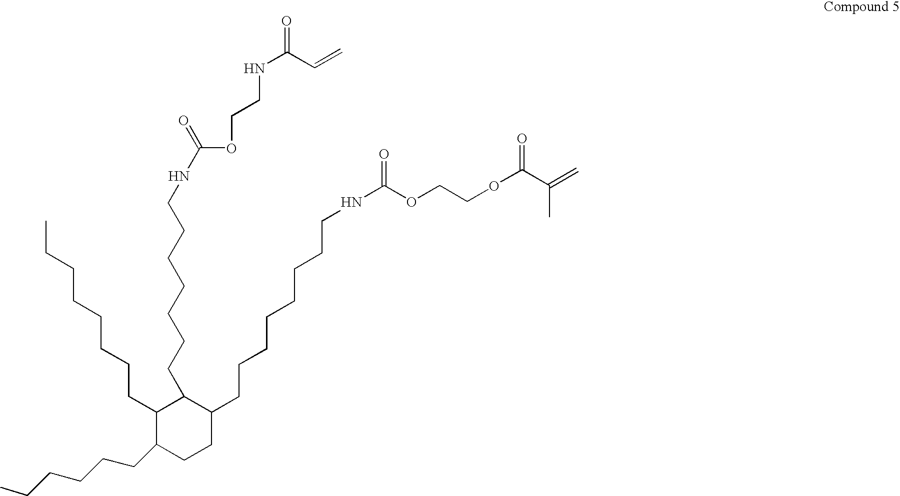 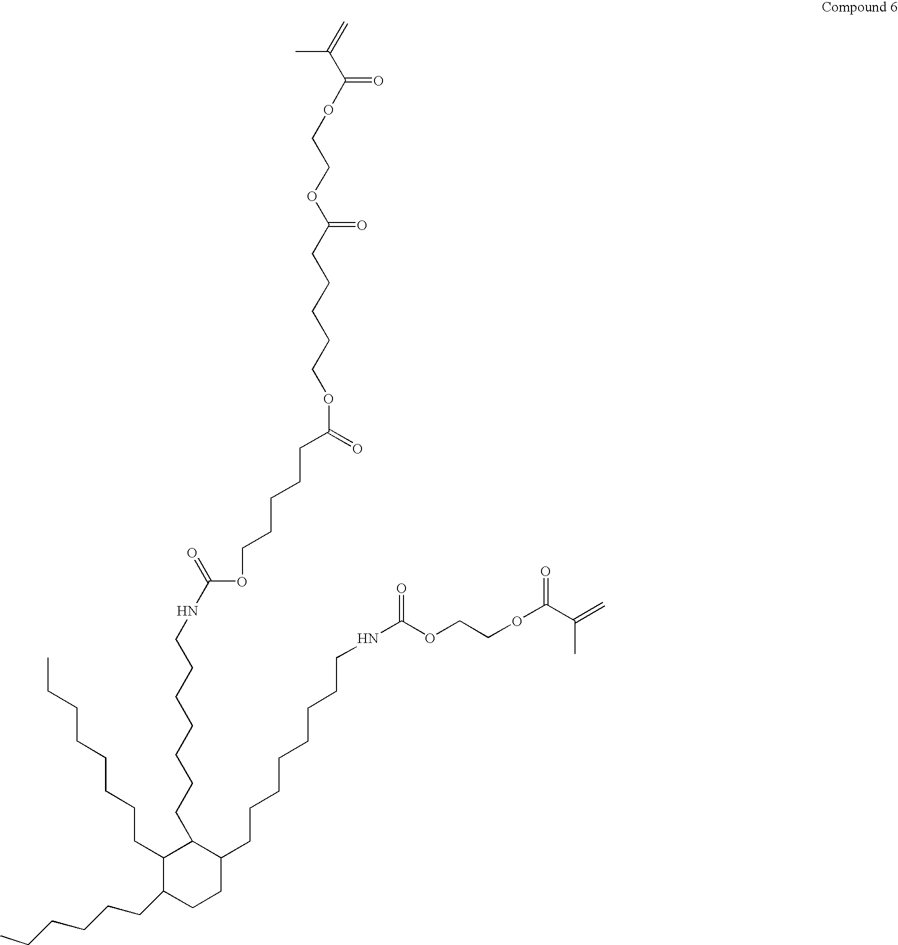 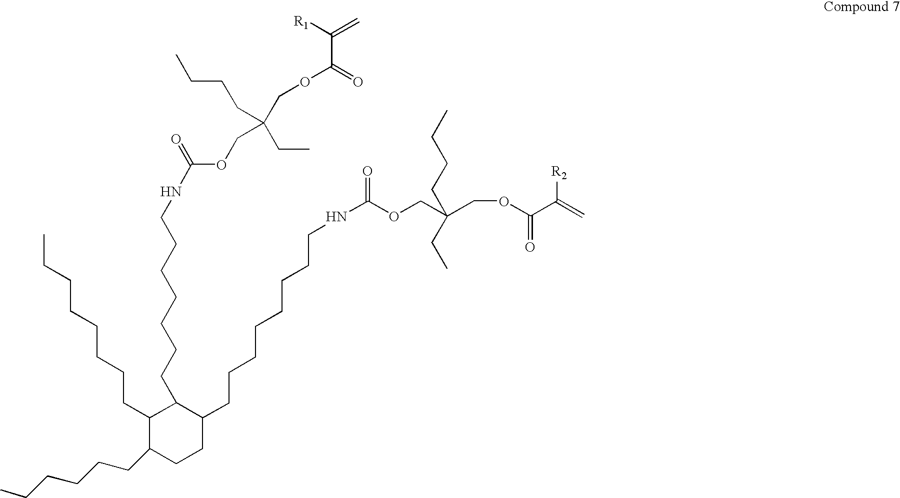
wherein R₁ and R₂ are each independently —H or methyl. 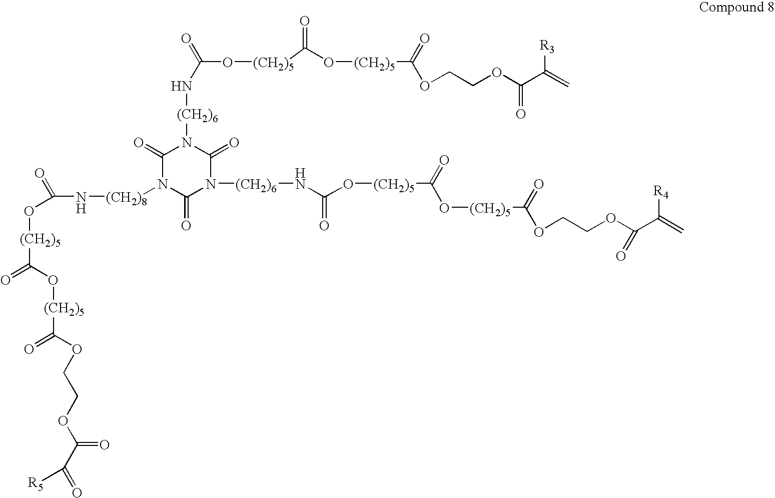
   wherein R₃, R₄, and R₅ are each independently —H or methyl.

The following table provides examples of certain variables from various Markush groups in this application. One of ordinary skill in the art will recognize that the variables and groups of variables may be selected in any combination. One of ordinary skill in the art will also recognize that this table is merely illustrative of certain combinations and does not limit the invention in any way.

| | Markush Group A | Markush Group B | Markush Group C | Markush Group D |
|---|---|---|---|---|
| X | unsubstituted | C₂-C₁₀₀ substituted | C₂-C₅₀ substituted | C₆-C₁₄ substituted |
| | aliphatic, aryl or | or unsubstituted | or unsubstituted | or unsubstituted |
| | heterocyclic, or | linear, branched, or | linear, branched, or | aryl or heterocyclic |
| | aliphatic, aryl or | cyclic aliphatic | cyclic aliphatic | moiety |
| | heterocyclic, | moiety | moiety | |
| | substituted with | | | |
| | one or morealkyl, | | | |
| | alkenyl, alkynyl, | | | |
| | hydroxy, oxo, | | | |
| | alkoxy, mercapto, | | | |
| | cycloalkyl, | | | |
| | substituted | | | |
| | cycloalkyl, | | | |
| | heterocyclic, | | | |
| | substituted | | | |
| | heterocyclic, aryl, | | | |
| | substituted aryl, | | | |
| | heteroaryl, | | | |
| | substituted | | | |
| | heteroaryl, aryloxy, | | | |
| | substituted aryloxy, | | | |
| | halogen, haloalkyl, | | | |
| | cyano, nitro, | | | |
| | nitrone, amino, | | | |
| | amido, —C(O)H, | | | |
| | —C(O)—, —C(O)—, —S—, | | | |
| | —S(O)₂, —OC(O)—O—, | | | |
| | —NR—C(O), —NR— | | | |
| | C(O)—NR, —OC(O)— | | | |
| | NR | | | |
| R | H, lower alkyl, | H, lower alkyl, or | H or C₁-C₄ alkyl | H or methyl |
| | acyl, oxyacyl, | acyl | | |
| | carboxyl, | | | |
| | carbamate, | | | |
| | sulfonyl, | | | |
| | sulfonamide, or | | | |
| | sulfuryl | | | |
| E | acrylate, | Acrylate or | Maleimide or | vinyl ether |
| | methacrylate, | methacrylate | epoxy | |
| | olefin, epoxy, | | | |
| | maleimide, vinyl | | | |
| | ether, or vinyl ester | | | |
| L | a bond or a | C₁-C₂₀ alkylene or | C₁-C₁₀ alkylene or | C₁-C₅ alkylene or |
| | substituted or | oxyalkylene linker | oxyalkylene linker | oxyalkylene linker |
| | unsubstituted | | | |
| | alkylene or | | | |
| | substituted or | | | |
| | unsubstituted | | | |
| | oxyalkylene linker | | | |
| | heteroaryl | | | |
| n | 1-10 | 1-5 | 1-3 | 2 |

In a further embodiment of the invention, there are provided adhesive compositions including a functionalized urethane compound of the invention and at least one curing initiator. In some embodiments, the functionalized urethane compound is present in the composition from about about 2 weight percent to about 98 weight percent (wt %) based on total weight of the composition. In other embodiments, there is at least additional compound that can co-cure with the functionalized urethane. The additional compound is typically present in the composition from about 10 wt % to about 90 wt % based on total weight of the composition. Such additional compounds include, for example, epoxies (such as phenolics, novalacs (both phenolic and cresolic) and the like), imides, monomaleimides, bismaleimides, polymaleimides, cyanate esters, vinyl ethers, vinyl esters, vinyl acetates, esters, ureas, amides, olefins (such as ethylenes, propylenes, and the like) siloxanes, cyanoacrylates, styrenes, oxazolines, benzoxazines, oxetanes, and the like, or combinations thereof.

The at least one curing initiator is typically present in the composition from about 0.1 wt % to about 5 wt % based on total weight of the composition. In some embodiments, the curing initiator is a free-radical initiator. As used herein, the term “free radical initiator” refers to any chemical species which, upon exposure to sufficient energy (e.g., light, heat, or the like), decomposes into two parts which are uncharged, but which each possess at least one unpaired electron. Free radical initiators contemplated for use in the practice of the present invention are compounds which decompose (i.e., have a half life in the range of about 10 hours) at temperatures in the range of about 70° C. up to about 180° C. Exemplary free radical initiators contemplated for use in the practice of the present invention include peroxides (e.g., dicumyl peroxide, dibenzoyl peroxide, 2-butanone peroxide, tert-butyl perbenzoate, di-tert-butyl peroxide, 2,5-bis(tert-butylperoxy)-2,5-dimethylhexane, bis(tert-butyl peroxyisopropyl)benzene, and tert-butyl hydroperoxide), azo compounds (e.g., 2,2′-azobis(2-methyl-propanenitrile), 2,2′-azobis(2-methylbutanenitrile), and 1,1′-azobis(cyclohexanecarbonitrile)), and the like.

The term “free radical initiator” also includes photoinitiators. For example, for invention adhesive compositions that contain a photoinitiator, the curing process can be initiated by UV radiation. In one embodiment, the photoinitiator is present at a concentration of 0.1 wt % to 5 wt % based on the total weight of the organic compounds in the composition (excluding any filler). In a one embodiment, the photoinitiator comprises 0.1 wt % to 3.0 wt %, based on the total weight of the organic compounds in the composition. Photoinitiators include benzoin derivatives, benzilketals, α,α-dialkoxyacetophenones, α-hydroxyalkylphenones, α-aminoalkylphenones, acylphosphine oxides, titanocene compounds, combinations of benzophenones and amines or Michier's ketone, and the like.

In a further embodiment, there are provided die-attach pastes comprising:
a) about 2 weight percent to about 98 weight percent (wt %) of at least one invention functionalized urethane compound, based on total weight of the composition;
b) 0 wt % to about 90 wt % of a filler;
c) about 0.1 wt % to about 5 wt % of at least one curing initiator, based on total weight of the composition;
d) about 0.1 wt % to about 4 wt %, of at least one coupling agent, based on total weight of the composition.

The die-attach pastes described herein may further comprise additional compounds that can co-cure with the functionalized urethane. Such compounds include, for example, epoxies (such as phenolics, novalacs (both phenolic and cresolic) and the like), imides, monomaleimides, bismaleimides, polymaleimides, cyanate esters, vinyl ethers, vinyl esters, vinyl acetates, esters, ureas, amides, olefins (such as ethylenes, propylenes, and the like) siloxanes, cyanoacrylates, styrenes, oxazolines, benzoxazines, oxetanes, and the like, or combinations thereof.

Fillers contemplated for use in the practice of the present invention can be electrically conductive and/or thermally conductive. In addition, the fillers may act to modify the rheology of the resulting composition or die-attach paste. Examples of suitable electrically conductive fillers which can be employed in the practice of the present invention include silver, nickel, copper, aluminum, palladium, gold, graphite, metal-coated graphite (e.g., nickel-coated graphite, copper-coated graphite, and the like), and the like. Examples of suitable thermally conductive fillers which can be employed in the practice of the present invention include graphite, aluminum nitride, silicon carbide, boron nitride, diamond dust, alumina, and the like. Compounds that act primarily to modify rheology include polysiloxanes (such as polydimethyl siloxanes) silica, fumed silica, alumina, titania, and the like.

As used herein, the term “coupling agent” refers to chemical species that are capable of bonding to a mineral surface and which also contain polymerizably reactive functional group(s) so as to enable interaction with the adhesive composition and/or die-attach paste. Coupling agents thus facilitate linkage of the die-attach paste to the substrate to which it is applied.

Exemplary coupling agents contemplated for use in the practice of the present invention include silicate esters, metal acrylate salts (e.g., aluminum methacrylate), titanates (e.g., titanium methacryloxyethylacetoacetate triisopropoxide), or compounds that contain a copolymerizable group and a chelating ligand (e.g., phosphine, mercaptan, acetoacetate, and the like). In some embodiments, the coupling agents contain both a co-polymerizable function (e.g., vinyl moiety, acrylate moiety, methacrylate moiety, and the like), as well as a silicate ester function. The silicate ester portion of the coupling agent is capable of condensing with metal hydroxides present on the mineral surface of substrate, while the co-polymerizable function is capable of co-polymerizing with the other reactive components of invention die-attach paste. In certain embodiments coupling agents contemplated for use in the practice of the invention are oligomeric silicate coupling agents such as poly(methoxyvinylsiloxane).

In some embodiments, both photoinitiation and thermal initiation may be desirable. For example, curing of a photoinitiator-containing adhesive can be started by UV irradiation, and in a later processing step, curing can be completed by the application of heat to accomplish a free-radical cure. Both UV and thermal initiators may therefore be added to the adhesive composition.

In general, the adhesive compositions and/or die-attach pastes will cure within a temperature range of 80-220° C., and curing will be effected within a length of time of less than 1 minute to 60 minutes. As will be understood by those skilled in the art, the time and temperature curing profile for each adhesive composition will vary, and different compositions can be designed to provide the curing profile that will be suited to the particular industrial manufacturing process.

In certain embodiments, the adhesive compositions and/or die-attach pastes may contain compounds that lend additional flexibility and toughness to the resultant cured adhesive. Such compounds may be any thermoset or thermoplastic material having a Tg of 50° C. or less, and typically will be a polymeric material characterized by free rotation about the chemical bonds, the presence of ether groups, and the absence of ring structures. Suitable such modifiers include polyacrylates, poly(butadiene), polyTHF (polymerized tetrahydrofuran, also known as poly(1,4-butanediol)), CTBN (carboxy-terminated butadiene-acrylonitrile) rubber, and polypropylene glycol. When present, toughening compounds may be in an amount up to about 15 percent by weight of the maleimide and other monofunctional vinyl compound.

Inhibitors for free-radial cure may also be added to the adhesive compositions and die-attach pastes described herein to extend the useful shelf life of compositions containing the functionalized urethane compounds described herein. Examples of these inhibitors include hindered phenols such as 2,6-di-tert-butyl-4-methylphenol; 2,6-di-tert-butyl-4-methoxyphenol; tert-butyl hydroquinone; tetrakis(methylene(3,5-di-tert-butyl-4-hydroxyhydrocinnamate))benzene; 2,2′-methylenebis(6-tert-butyl-p-cresol); and 1,3,5-trimethyl-2,4,6-tris(3′,5′-di-tert-butyl-4-hydroxybenzyl)benzene. Other useful hydrogen-donating antioxidants include derivatives of p-phenylenediamine and diphenylamine. It is also well know in the art that hydrogen-donating antioxidants may be synergistically combined with quinones, and metal deactivators to make a very efficient inhibitor package. Examples of suitable quinones include benzoquinone, 2-tert butyl-1,4 benzoquinone; 2-phenyl-1,4-benzoquinone; naphthoquinone, and 2,5-dichloro-1,4-benzoquinone. Examples of metal deactivators include N,N′-bis(3,5-di-tert-butyl-4-hydroxyhydrocinnamoyl)hydrazine; oxalyl bis(benzylidenehydrazide); and N-phenyl-N′-(4-toluenesulfonyl)-p-phenylenediamine. Nitroxyl radical compounds such as TEMPO (2,2,6,6-tetramethyl-1-piperidnyloxy, free radical) are also effective as inhibitors at low concentrations. The total amount of antioxidant plus synergists typically falls in the range of 100 to 2000 ppm relative to the weight of total base resin. Other additives, such as adhesion promoters, in types and amounts known in the art, may also be added.

The adhesive compositions and die-attach pastes described herein will perform within the commercially acceptable range for die-attach adhesives. Commerically acceptable values for die shear for the adhesives on a 80×80 mil² silicon die are in the range of greater than or equal to 1 kg at room temperature, and greater than or equal to 0.5 kg at 240° C. Acceptable values for warpage for a 500×500 mil² die are in the range of less than or equal to 70 Nm at room temperature.

In yet another embodiment of the invention, there are provided assemblies of components adhered together employing the above-described adhesive compositions and/or die-attach pastes. Thus, for example, assemblies comprising a first article adhered to a second article by a cured aliquot of the above-described adhesive composition are provided. Articles of the present invention can be any article of manufacture for which adhesion to another article is desired. Articles particularly contemplated for assembly employing invention compositions include electronic articles such as memory devices, ASIC devices, microprocessors, flash memory devices, and the like. Also contemplated are assemblies comprising a microelectronic device permanently adhered to a substrate by a cured aliquot of the above-described die-attach paste. Microelectronic devices contemplated for use with invention die-attach pastes include copper lead frames, Alloy 42 lead frames, silicon dice, gallium arsenide dice, germanium dice, and the like.

In other embodiments of the invention, there are provided methods for adhesively attaching a first article to a second article. Such methods can be performed, for example, by
(a) applying an aliquot of an invention adhesive composition to the first article,
(b) bringing the first and second article into contact to form an assembly wherein the first article and the second article are separated only by the adhesive composition applied in (a), and, (c) subjecting the assembly to conditions suitable to cure the adhesive composition.

In still further embodiments, there are provided methods for adhesively attaching a semiconductor die to a substrate. Such methods can be performed, for example, by
(a) applying an invention die-attach paste to the substrate and/or the semiconductor die,
(b) bringing the substrate and the die into contact to form an assembly wherein the substrate and the die are separated only by the die-attach paste applied in (a), and,
(c) subjecting the assembly to conditions suitable to cure the die-attach paste.

Conditions suitable to cure invention die-attach pastes include subjecting the above-described assembly to a temperature of less than about 200° C. for about 0.5 up to about 2 minutes. This rapid, short duration heating can be accomplished in a variety of ways, e.g., with an in-line heated rail, a belt furnace, or the like, as will be well known to the skilled artisan. Optionally, the pastes can be oven cured at 150-220° C.

The invention will now be further described with reference to the following non-limiting examples.

### EXAMPLES

### Example 1

### Synthesis of Compounds 1a and 1b

This example describes the preparation of an invention functionalized urethane compound bearing two acrylate moieties. The preparation of Compound 1a set forth below utilizes a catalyst, while the preparation of Compound 1b does not use a catalyst.

Compound 1a. A 250 mL flask was charged with a di-isocyanate, DDI-1410 (Cognis), (29.4 g, 50 mmol), the structure of this di-isocyanate compound is shown below: 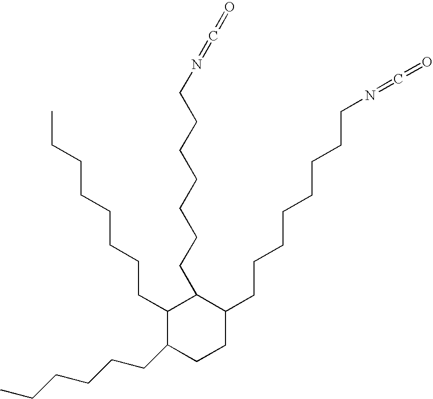
and 4-hydroxybutyl acrylate (15.1 g, 105 mmol). This mixture was heated to 75° C. and the reaction was allowed to proceed for 8 hours, followed by sparging for 2.5 hours. Infrared spectrometry confirmed disappearance of the isocyanate and formation of the urethane linkage. Thermogravimetric analysis (TGA) revealed this compound is stable up to 300° C.

Compound 1b. A one quart glass jar was equipped with a high shear mixture. To this jar was added DDI-1410 (400 g, 680 mmol), 2-hydroxyethyl methacrylate (92 g, 707 mmol), and 2-hydroxyethyl acrylate (82 g, 707 mmol). Stirring began and within one hour the temperature rose to about 75° C., and then stabilized to about 80° C. for the next 4 hours. The reaction was allowed to proceed for an additional 2 hours, when IR analysis revealed the reaction was complete by absence of the isocyanate peak.

### Example 2

### Synthesis of Compound 2

A one quart glass jar was equipped with a high shear mixture. To this jar was added DDI-1410 (400 g, 680 mmol), 2-hydroxyethyl methacrylate (92 g, 707 mmol), and glycidol (52 g, 707 mmol). Stirring began and within one hour the temperature rose to about 75° C., and then stabilized to about 80° C. for the next 4 hours. The reaction was allowed to proceed for an additional 2 hours, when IR analysis revealed the reaction was complete by absence of the isocyanate peak.

### Example 3

### Synthesis of Compound 3

This Example describes the preparation of an invention functionalized urethane compound bearing two oxetane moieties. To a 125 mL flask was added DDI-1410 (Cognis, structure set forth in Example 1, 29.4 g, 50 mmol) and 3-ethyl-3-hydroxymethyl-oxetane (11.7 g, 101 mmol). The mixture was allowed to stir at 70° C. for 5 hours. After this time, an additional aliquot of 3-ethyl-3-hydroxymethyl-oxetane (1.2 g) was added to the flask and the reaction was allowed to proceed at 70° C. for an additional 4 hours. After sparging for 3 hours at 70° C., the product was obtained as a viscous, yellow liquid at room temperature. Infrared spectrometry confirmed disappearance of the isocyanate and formation of the urethane linkage. TGA confirmed thermal stability greater than 260° C.

### Example 4

### Synthesis of Compound 4

This Example describes the preparation of an invention functionalized urethane compound bearing both a methacrylate moiety and an oxetane moiety. To a 125 mL flask was added DDI-1410 (Cognis, structure set forth in Example 1, 29.4 g, 50 mmol), 3-ethyl-3-hydroxymethyl-oxetane (3.0 g, 26 mmol), and 2-hydroxyethyl methacrylate (3.4 g, 26 mmol). This reaction mixture was heated to 65-70° C. and the reaction was allowed to proceed for 8 hours. Following the reaction, the mixture was sparged for 2 hours at 80° C. Infrared spectrometry confirmed disappearance of the isocyanate and formation of the urethane linkage. TGA confirmed thermal stability greater than 260° C.

### Example 5

### Synthesis of Compound 5

This Example describes the preparation of an invention functionalized urethane bearing both a methacrylate moiety and an acrylamide moiety. To a 250 mL flask was added DDI-1410 (Cognis, structure set forth in Example 1, 29.4 g, 50 mmol), 2-hydroxyethylacrylamide (6.3 g, 55 mmol), and 2-hydroxyethylmethacrylate (7.2 g, 55 mmol). The mixture was heated to 65-70° C. and the reaction was allowed to proceed for 12 hours. Following the reaction, the mixture was sparged for 2 hours at 70° C. Infrared spectrometry confirmed disappearance of the isocyanate and formation of the urethane linkage. TGA confirmed thermal stability greater than 260° C.

While this invention has been described with respect to these specific examples, it should be clear that other modifications and variations are possible without departing from the spirit of the invention.

1. A functionalized urethane compound having the formula I: 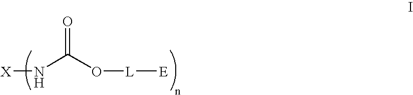
wherein:
X is a substituted or unsubstituted aliphatic, aryl, or heterocyclic;
each E is independently a polymerizable moiety selected from the group consisting of acrylate, methacrylate, acrylamide, methacrylamide, olefin, epoxy, maleimide, vinyl ether, and vinyl ester;
each L is independently a substituted or unsubstituted alkylene, substituted or unsubstituted arylene, or substituted or unsubstituted oxyalkylene linker; and
n is 1 to about 10.

2. The compound of claim 1, wherein X is a substituted or unsubstituted linear, branched, or cyclic aliphatic moiety having from 2 to about 100 carbon atoms.

3. The compound of claim 1, wherein X is a substituted or unsubstituted aryl or heterocyclic moiety having from about 6 to about 14 carbon atoms.

4. The compound of claim 1, wherein X is a substituted or unsubstituted linear, branched, or cyclic aliphatic moiety having from 2 to about 50 carbon atoms.

5. The compound of claim 1, wherein n is 1 to about 5.

6. The compound of claim 1, wherein n is 1 to about 3.

7. The compound of claim 1, wherein n is 2.

8. The compound of claim 1, wherein L is a C₁-C₂₀ alkylene or oxyalkylene linker.

9. The compound of claim 1, wherein L is a C₁-C₁₀ alkylene or oxyalkylene linker.

10. The compound of claim 1, wherein L is a C₁-C₅ alkylene or oxyalkylene linker.

11. The compound of claim 1, wherein E is an acrylate or methacrylate.

12. The compound of claim 1, wherein E is a maleimide.

13. The compound of claim 1, wherein E is an epoxy.

14. The compound of claim 1, wherein E is a vinyl ether.

15. The compound of claim 1, wherein the substituted aliphatic, aryl, or heterocyclic moieties comprise substituents selected from alkyl, alkenyl, alkynyl, hydroxy, oxo, alkoxy, mercapto, cycloalkyl, substituted cycloalkyl, heterocyclic, substituted heterocyclic, aryl, substituted aryl, heteroaryl, substituted heteroaryl, aryloxy, substituted aryloxy, halogen, haloalkyl, cyano, nitro, nitrone, amino, amido, —C(O)H, —C(O)—, —C(O)—, —S—, —S(O)₂, —OC(O)—O—, —NR—C(O), —NR—C(O)—NR, —OC(O)—NR, wherein R is H, lower alkyl, acyl, oxyacyl, carboxyl, carbamate, sulfonyl, sulfonamide, or sulfuryl.

16. A compound having the formula: 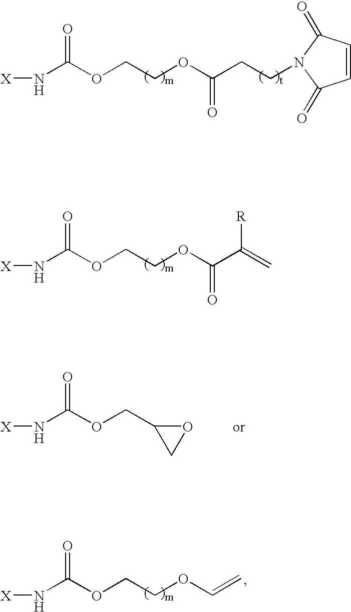
wherein:
X is a substituted or unsubstituted aliphatic, aryl, or heterocyclic,
M and t are each independently 1 to about 20, and
R is H or methyl.

17. A compound having the formula: 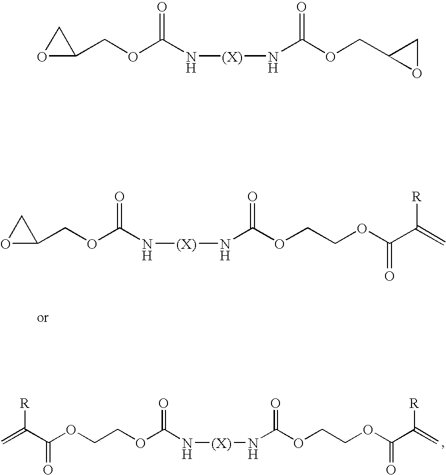
wherein
X is a substituted or unsubstituted aliphatic, aryl, or heterocyclic, and
each R is H or methyl.

18. An adhesive composition comprising at least one compound of claim 1, and at least one curing initiator.

19. The adhesive composition of claim 18, further comprising at least one additional compound selected from the group consisting of acrylates, methacrylates, maleimides, vinyl ethers, vinyl esters, styrenic compounds and allyl functional compounds.

20. The adhesive composition of claim 19, wherein the additional compound is selected from the group consisting of acrylates, methacrylates, and maleimides.

21. The adhesive composition of claim 19, wherein the compound is a maleimide.

22. The adhesive composition of claim 18, further comprising a reactive diluent.

23. The adhesive composition of claim 18, further comprising a filler.

24. The adhesive composition of claim 23, wherein the filler is conductive.

25. The adhesive composition of claim 24, wherein the filler is thermally conductive.

26. The adhesive composition of claim 24, wherein the filler is electrically conductive.

27. The adhesive composition of claim 23, wherein the filler is non-conductive.

28. The adhesive composition of claim 18, wherein the at least one curing initiator comprises about 0.1 wt % to about 5 wt % based on total weight of the composition.

29. The adhesive composition of claim 18, wherein the curing initiator comprises a free-radical initiator or a photoinitiator.

30. A die-attach paste comprising:
a) about 2 weight percent to about 98 weight percent (wt %) of at least one compound of claim 1, based on total weight of the die-attach paste;
b) 0 wt % to about 90 wt % of a filler;
c) about 0.1 wt % to about 5 wt % of at least one curing initiator, based on total weight of the die-attach paste;
d) about 0.1 wt % to about 4 wt %, of at least one coupling agent, based on total weight of the die-attach paste.

31. The die-attach paste of claim 30, further comprising at least one additional compound selected from the group consisting of acrylates, methacrylates, maleimides, vinyl ethers, vinyl esters, styrenic compounds and allyl functional compounds.

32. The die-attach paste of claim 31, wherein the additional compound is selected from the group consisting of acrylates, methacrylates, or maleimides.

33. The die-attach paste of claim 31, wherein the compound is a maleimide.

34. The die-attach paste of claim 30, wherein the filler is conductive.

35. The die-attach paste of claim 34, wherein the filler is thermally conductive.

36. The die-attach paste of claim 34, wherein the filler is electrically conductive.

37. The die-attach paste of claim 30, wherein the filler is non-conductive.

38. The die-attach paste of claim 30, wherein the coupling agent is a silicate ester, a metal acrylate salt, or a titanate.

39. An assembly comprising a first article adhered to a second article by a cured aliquot of the die-attach paste of claim 30.

40. An assembly comprising a first article adhered to a second article by a cured aliquot of the die-attach paste of claim 31.

41. A method for adhesively attaching a first article to a second article, comprising:
(a) applying an aliquot of the adhesive composition of claim 18 to the first article,
(b) bringing the first and second article into contact to form an assembly, wherein the first article and the second article are separated only by the adhesive composition applied in (a), and,
(c) subjecting the assembly to conditions suitable to cure the adhesive composition, thereby adhesively attaching the first article to the second article.

42. A method for adhesively attaching a semiconductor die to a substrate comprising:
(a) applying the die-attach paste of claim 30 to the substrate and/or the semiconductor die,
(b) bringing the substrate and the die into contact to form an assembly, wherein the substrate and the die are separated only by the die attach paste applied in (a), and,
(c) subjecting the assembly to conditions suitable to cure the die-attach paste, thereby adhesively attaching the semiconductor die to the substrate

43. A compound having the structure:

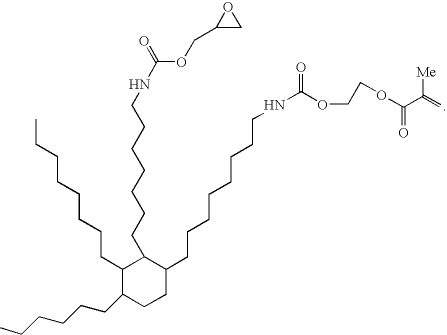

44. A compound having the structure:

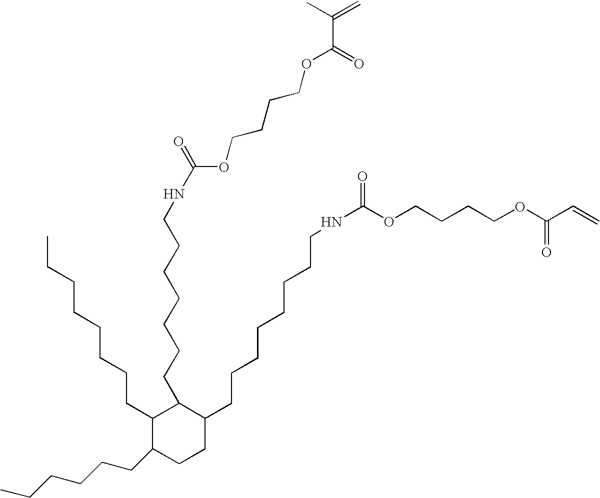

45. A die-attach paste comprising:
a) about 2 weight percent to about 98 weight percent (wt %) based on total weight of the composition of a compound having the structure: 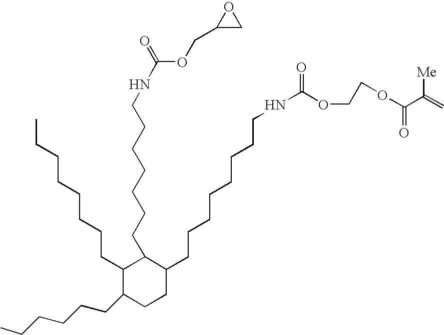
b) 0 wt % to about 90 wt % of a filler;
c) about 0.1 wt % to about 5 wt % of at least one curing initiator, based on total weight of the composition;
d) about 0.1 wt % to about 4 wt %, of at least one coupling agent, based on total weight of the die-attach paste.

46. A die-attach paste comprising:
a) about 2 weight percent to about 98 weight percent (wt %) based on total weight of the composition of a compound having the structure; 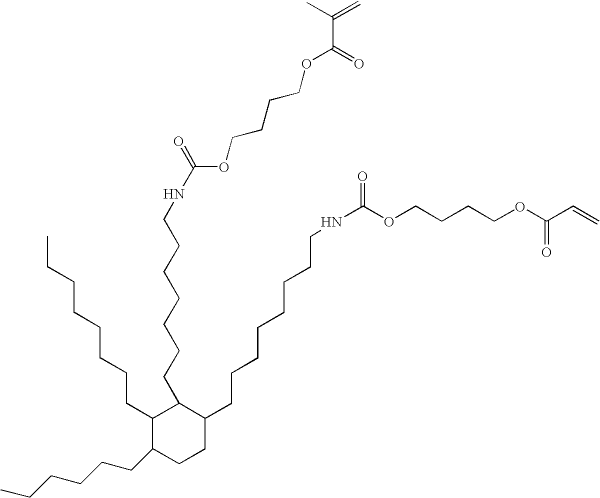
b) 0 wt % to about 90 wt % of a filler;
c) about 0.1 wt % to about 5 wt % of at least one curing initiator, based on total weight of the composition;
d) about 0.1 wt % to about 4 wt %, of at least one coupling agent, based on total weight of the die-attach paste.
